(19) United States
(12) Patent Application Publication
(10) Pub. No.: US 2024/0195734 A1
(43) Pub. Date: Jun. 13, 2024

(54) COMMUNICATION SYSTEM, GATEWAY, CONTROLLER AND COMPUTER-READABLE STORAGE MEDIUM

(71) Applicant: SoftBank Corp., Tokyo (JP)

(72) Inventor: Satoru MATSUSHIMA, Tokyo (JP)

(21) Appl. No.: 18/583,799

(22) Filed: Feb. 21, 2024

Related U.S. Application Data
(63) Continuation of application No. PCT/JP2022/033880, filed on Sep. 9, 2022.

(30) Foreign Application Priority Data
Sep. 13, 2021 (JP) 2021-148957
Mar. 3, 2022 (JP) 2022-032733

(51) Int. Cl. H04L 45/00; H04L 45/02; H04L 45/76

(52) U.S. Cl. CPC H04L 45/34; H04L 45/02; H04L 45/76

(57) ABSTRACT

Provided is a communication system comprising: a controller; an SR gateway, wherein the SR gateway includes: an advertisement unit which advertises, when path information of the IP network and an SID of a VRF are received from the VRF, an SR policy including the information of VRF to an ED of an NLRI and an SID of the SR gateway to the controller, and the controller includes: a matching unit which matches the VRF and the SR gateway; an identification unit which identifies, by referring to a PFCP session, a UPF and a gNB corresponding to the IP network to which the VRF is connected; and an advertisement unit which advertises path information of the UPF and an SID of the SR gateway to a VRF corresponding to the gNB identified by the identification unit.

The contents of the following patent application(s) are incorporated herein by reference:
NO. 2021-148957 filed in JP on Sep. 13, 2021
NO. 2022-032733 filed in JP on Mar. 3, 2022
NO. PCT/JP2022/033880 filed in WO on Sep. 9, 2022

### BACKGROUND

### 1. Technical Field

The present invention relates to a communication system, a gateway, a controller and a computer-readable storage medium.

### 2. Related Art

Patent document 1 describes about slicing in a mobile network compliant with 5G (5th Generation).

### PRIOR ART DOCUMENT

### Patent Document

Patent Document 1: Japanese Patent Application Publication No. 2019-176384

### BRIEF DESCRIPTION OF THE DRAWINGS

FIG. 1 schematically illustrates an example of a configuration of a communication system 10.

FIG. 2 is an illustration for describing an example of a process in the communication system 10.

FIG. 3 schematically illustrates an example of a functional configuration of an N4BGPC 300.

FIG. 4 schematically illustrates an example of a logical configuration of a converter unit 410.

FIG. 5 is an illustration for describing an example of a process in the communication system 10.

FIG. 6 schematically illustrates an example of a functional configuration of an N4BGPC 300.

FIG. 7 schematically illustrates an example of a logical configuration of a converter unit 410.

FIG. 8 schematically illustrates an example of a hardware configuration of a computer 1200 that functions as an N4BGPC 300 or a SRGW 400.

### DESCRIPTION OF EXEMPLARY EMBODIMENTS

Although a technology for identifying network slices in a mobile network is known, it was closed in the mobile network. Although it is desirable to be able to make the network slices including an IP network to be manageable, setting of path information or the like may be very complicated. In a communication system 10 according to the present embodiment, a technology for reducing complexity of the setting is provided.

Hereinafter, the present invention will be described through embodiments of the invention, but the following embodiments do not limit the invention according to claims. In addition, not all of the combinations of features described in the embodiments are essential to the solution of the invention.

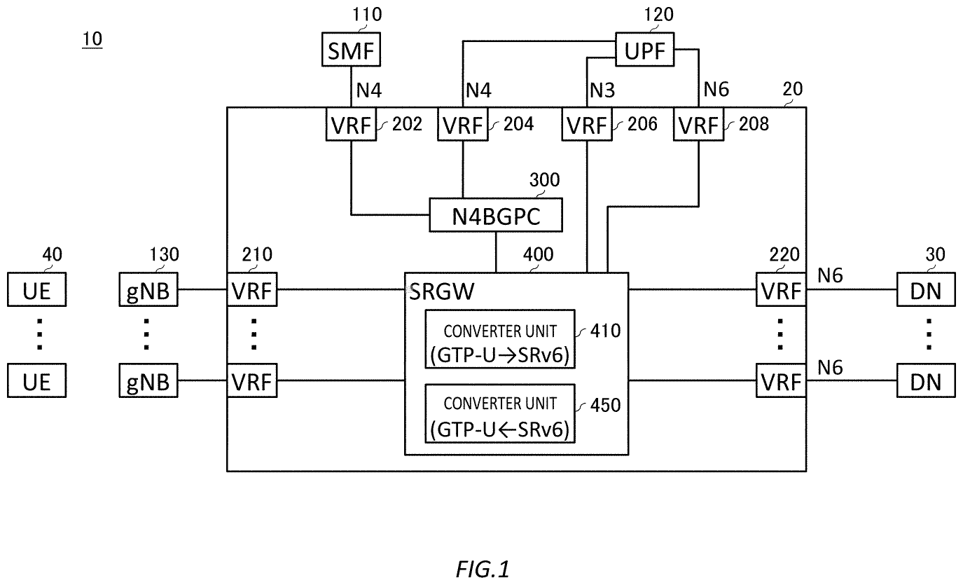

FIG. 1 schematically illustrates an example of a configuration of a communication system 10. The communication system 10 includes an N4BGPC (N4 Border Gateway Protocol Controller) 300. The N4BGPC 300 may be an example of a controller. The N4BGPC 300 may be arranged within a SRNW (Segment Routing Network) 20. The communication system 10 includes a SRGW (Segment Routing Gateway) 400. The SRGW 400 may be arranged within the SRNW 20.

The SRGW 400 may have a function for converting a packet compliant with an SRv6 that is received from the IP network into a packet compliant with a GTP-U. The SRGW 400 may have a function for converting a packet compliant with the GTP-U that is received from the mobile network into a packet compliant with the SRv6.

The N4BGPC 300 controls the SRGW 400. The N4BGPC 300 may perform a process related to a path control of the SRGW 400.

In the example shown in FIG. 1, in the SRNW 20, a VRF (Virtual Routing and Forwarding) 202, a VRF 204, a VRF 206, a VRF 208, a VRF 210 and a VRF 220 are arranged. Note that the illustration of a router in which each VRF is implemented is omitted. The SRGW 400 may include the VRF 210. The SRGW 400 may include the VRF 220. The SRGW 400 may include both the VRF 210 and the VRF 220.

The VRF 202 is connected to a SMF (Session Management Function) 110. The VRF 204, the VRF 206 and the VRF 208 are connected to a UPF (User Plane Function) 120. The VRF 210 is connected to a gNB (gNodeB) 130. In the example shown in FIG. 1, each of a plurality of VRFs 210 is connected to a plurality of gNBs 130. The VRF 220 is connected to a DN (Data Network) 30. In the example shown in FIG. 1, each of a plurality of VRFs 220 is connected to a plurality of DNs 30.

The N4BGPC 300 acquires, from the SMF 110, information that is related to the mobile network. The N4BGPC 300 acquires, from the SMF 110, PFCP (Packet Forwarding Control Protocol) session information of the UE 40, for example.

The PFCP session information includes an address of the UE 40, for example. The PFCP session information includes an address of a gNB 130 that contains the UE 40, for example. The PFCP session information includes an address of a UPF 120 corresponding to the UE 40, for example. The PFCP session information includes a network instance corresponding to the UE 40, for example. The network instance is, for example, information corresponding to slice identification information that is capable of identifying a slice corresponding to the UE 40 in the mobile network, as an access network instance. The slice identification information is an S-NSSAI (Single-Network Slice Selection Assistance Information), for example. The PFCP session information may include an access network instance. The PFCP session information may include a core network instance. The core network instance is information corresponding to DN identification information capable of identifying the DN, for example.

The SRGW 400 includes a converter unit 410 and a converter unit 450. The converter unit 410 has a function for converting a packet compliant with the GTP-U into a packet compliant with the SRv6. The converter unit 410 may have a function of a GTP 4.D. The converter unit 410 may have a function of a GTP 6.D.

The converter unit 450 has a function for converting a packet compliant with the SRv6 into a packet compliant with the GTP-U. The converter unit 450 may have a function of a GTP 4.E. The converter unit 450 may have a function of a GTP 6.E.

In the present embodiment, the N4BGPC 300 performs a routing for relaying a communication between a UE (User Equipment) 40 that is connected to the gNB 130 and a communication partner that is connected to the DN 30. The communication partner may be any communication apparatus such as any server on the Internet, for example.

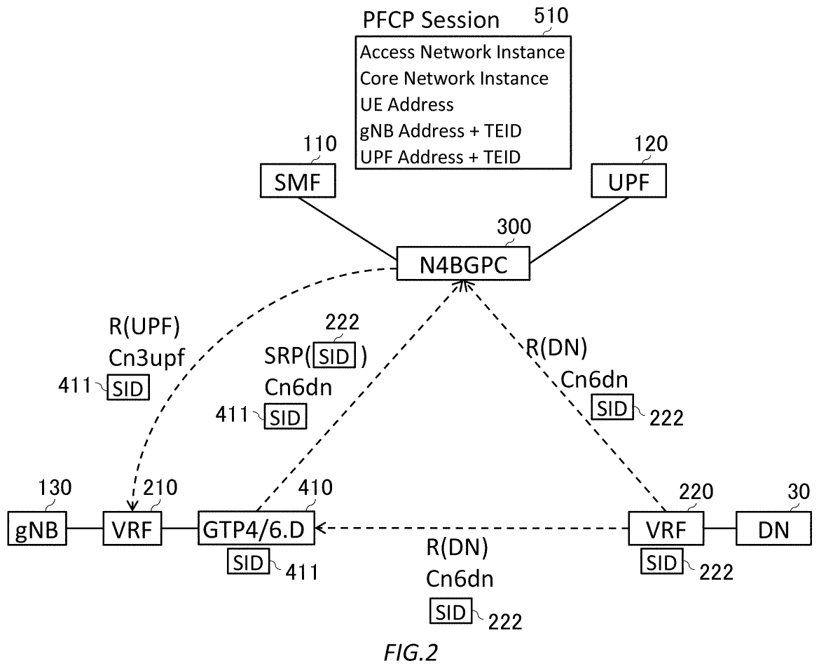

FIG. 2 is an illustration for describing an example of a process in the communication system 10. In the example shown in FIG. 2, the converter unit 410 of the SRGW 400 acquires a packet that is transmitted by the UE 40, which would be conventionally transferred to the UPF 120, and transfers the packet to the DN 30 via the VRF 220. The N4BGPC 300 performs the setting for the example above.

For example, the VRF 220 that is connected to the DN 30 first advertises path information of the DN 30, a community attribute indicating the DN, and an SID 222 of the VRF 220 to each of the N4BGPC 300 and the SRGW 400. The N4BGPC 300 may set the path information of the DN 30 in advance.

The converter unit 410 of the SRGW 400 advertises an SR policy including information indicating the VRF 220 to an ED (End Point) of an NLRI, the community attribute indicating the DN, and an SID 411 of the converter unit 410 to the N4BGPC 300 when it receives the advertisement from the VRF 220. The information indicating the VRF 220 may be an SID 222 of the VRF 220, for example.

The N4BGPC 300 matches the VRF 220 with the SRGW 400 based on the information of the DN 30 that is advertised from the VRF 220 or that is preset and the information that is advertised from the converter unit 410. The N4BGPC 300 refers to a PFCP session 510 that is notified from the SMF 110 when the UE 40 is attached, to identify the UPF 120 and the gNB 130 corresponding to the DN 30 to which the VRF 220 is connected. The N4BGPC 300 advertises path information of the UPF 120, a community attribute indicating the UPF, and an SID 411 of the converter unit 410, to the VRF 210 corresponding to the identified gNB 130.

When there is a plurality of SRGWs 400, those SRGWs 400 may advertise SR policies, each of which includes am individual SID 411 value, to the N4BGPC 300. The SRGW 400 may receive an SR policy including an SID 411 value advertised by another SRGW 400. The N4BGPC and all of the SRGWs 400 may select, by a common algorithm, the SID 411 advertised by any one of the SRGWs 400.

By the above-described configuration, when a packet received by the gNB 130 from the UE 40 is transferred to the VRF 210, the VRF 210 can transfer the packet to the SRGW 400. The converter unit 410 of the SRGW 400 converts the packet into a packet compliant with the SRv6, to transfer the converted packet to the VRF 220. The packet is transferred from the VRF 220 to the communication partner of the DN 30.

The converter unit 410 of the SRGW 400 may transfer a special packet to the UPF 120 rather than the DN 30. For example, the converter unit 410 of the SRGW 400 imports the SID of the VRF 206 corresponding to the UPF 120 as a path of the UPF 120, and transfers a predetermined type of packet to the UPF 120. Examples of the predetermined type of packet include a GTP-U message.

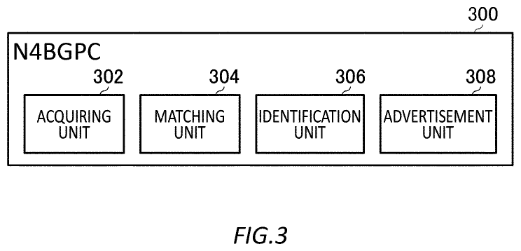

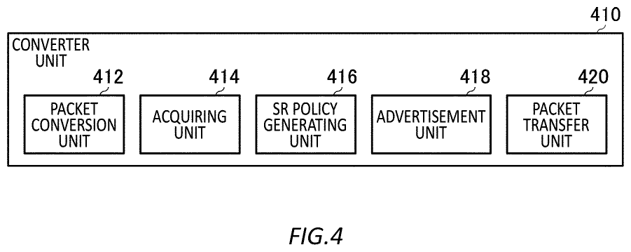

FIG. 3 schematically illustrates an example of a functional configuration of an N4BGPC 300. FIG. 4 schematically illustrates an example of a logical configuration of a converter unit 410. The N4BGPC 300 includes an acquiring unit 302, a matching unit 304, an identification unit 306 and an advertisement unit 308. The N4BGPC 300 may include a part of the above components rather than all of the above components, or may include a component other than the above components. The converter unit 410 includes a packet conversion unit 412, an acquiring unit 414, an SR policy generating unit 416, an advertisement unit 418 and a packet transfer unit 420. The converter unit 410 may include a part of the above components rather than all of the above components, or may include a component other than the above components.

The acquiring unit 302 acquires various types of information. For example, the acquiring unit 302 acquires the PFCP session 510 from the SMF 110. For example, the acquiring unit 302 acquires information advertised from the VRF. For example, the acquiring unit 302 acquires information advertised from the SRGW 400. The acquiring unit 302 may acquire preset path information of the DN 30.

The matching unit 304 performs a matching using the information acquired by the acquiring unit 302. For example, the matching unit 304 matches the VRF 220 with the SRGW 400 based on the information advertised from the VRF 220 and the information advertised from the converter unit 410 of the SRGW 400. In addition, for example, the matching unit 304 matches the VRF 220 with the SRGW 400 based on the path information of the DN 30 and the information advertised from the converter unit 410 of the SRGW 400.

The identification unit 306 performs an identification process related to the routing. For example, the identification unit 306 refers to the PFCP session 510 acquired by the acquiring unit 302 to identify the UPF 120 and the gNB 130 corresponding to the IP network to which the VRF 220 is connected.

The advertisement unit 308 performs an advertisement process. For example, the advertisement unit 308 advertises, to the VRF 210 corresponding to the gNB 130 that is identified by the identification unit 306, the path information of the UPF 120 that is identified by the identification unit 306, the community attribute indicating the UPF, and the SID 411 of the converter unit 410 of the SRGW 400.

The packet conversion unit 412 converts a packet compliant with the GTP-U into a packet compliant with the SRv6. The packet conversion unit 412 may convert a packet compliant with the GTP-U that is received from the mobile network into a packet compliant with the SRv6.

The acquiring unit 414 acquires various types of information. For example, the acquiring unit 414 acquires information advertised by the VRF.

The SR policy generating unit 416 generates an SR policy. The SR policy generating unit 416 generates an SR policy including an SID of the VRF within the ED of the NLRI, for example, when the acquiring unit 414 receives, from the VRF connected to the IP network, the path information of the IP network, a community attribute indicating the IP network, and the SID of the VRF.

The advertisement unit 418 performs an advertisement process. For example, the advertisement unit 418 advertises the SR policy generated by the SR policy generating unit 416, the community attribute indicating the IP network, and the SID of the SRGW 400 to the N4BGPC 300.

The packet transfer unit 420 transfers the packet. For example, when the packet addressed to the DN 30 is received from the VRF 210, the packet transfer unit 420 transfers the packet to the VRF 220 by using the path information received from the VRF 220.

The packet transfer unit 420 may transfer a special packet to the UPF 120 rather than the DN 30. For example, the packet transfer unit 420 imports the SID of the VRF 206 corresponding to the UPF 120 as a path of the UPF 120, and transfers a predetermined type of packet to the UPF 120. Examples of the predetermined type of packet include a GTP-U message.

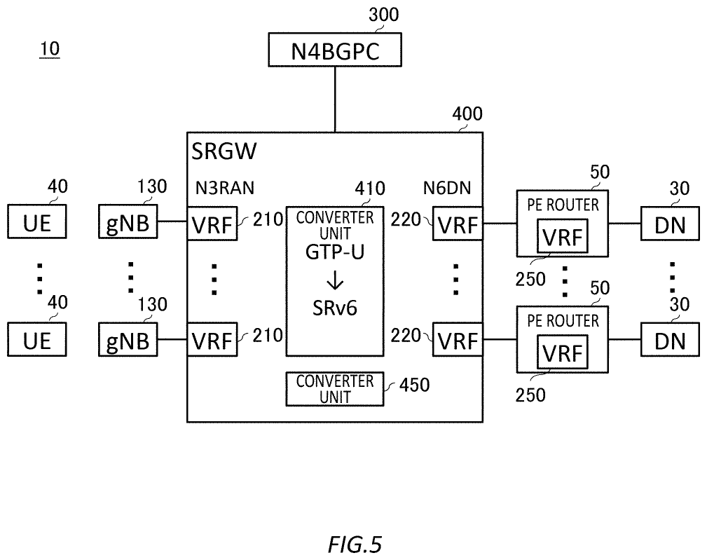

FIG. 5 is an illustration for describing an example of a process in the communication system 10. A process related to the transfer of the packet from the UE 40 to the DN 30 in the communication system 10 will be described herein.

In the example shown in FIG. 5, the SRGW 400 acquires a packet that is transmitted by the UE 40, which would be conventionally transferred to the UPF 120, and transfers the packet to the DN 30. The N4BGPC 300 performs the setting for the example above.

A VRF name of the VRF 210 corresponding to the gNB 130 will be described as N3RAN and a VRF name of the VRF 220 corresponding to the DN 30 will be described as N6DN herein.

For example, the N4BGPC 300 first generates a DN community association table for associating a DN name of the N6DN with a community attribute of the N6DN. As an example, the N4BGPC 300 generates a DN community association table with a format exemplified in the Table 1. The N4BGPC 300 then registers a combination of a plurality of DN names and the community attributes to the DN community association table. The N4BGPC 300 may perform the registering according to an instruction from an operator or the like.

TABLE 1

| COMMUNITY ATTRIBUTE | DN NAME |
|---|---|
| . | . |
| . | . |
| . | . |

The DN community association table may be an example of DN community association information associating the DN name of the N6DN with the community attribute of the N6DN. In this manner, the DN community association information may have a format of a table, but may be data associating the DN name of the N6DN with the community attribute of the N6DN without having a format of a table.

In addition, the N4BGPC 300 generates a DN table that is capable of registering an N3RAN prefix, an N6DN SID and an N3RAN community corresponding to each of the plurality of DN names. As an example, the N4BGPC 300 generates a DN table with a format exemplified in the Table 2.

TABLE 2

| N3RAN | N6DN | N3RAN |
|---|---|---|
| PREFIX | SID | COMMUNITY |
| . | . | . |
| . | . | . |
| . | . | . |

The DN table may be an example of DN related information that is capable of registering the N3RAN prefix, the N6DN SID and the N3RAN community. The DN related information may have a format of a table in this manner, but may be data associating the N3RAN prefix, the N6DN SID and the N3RAN community without having a format of a table.

The N4BGPC 300 then generates a DN table association table associating the DN name with a pointer indicating the DN table. As an example, the N4BGPC 300 generates a DN table association table with a format exemplified in the Table 3.

TABLE 3

| DN NAME | DN TABLE POINTER |
|---|---|
| . | . |
| . | . |
| . | . |

The DN table association table may be an example of DN related information association information associating the DN name with the pointer indicating the DN related information. In this manner, the DN related information association information may have a format of a table, but may be data associating the DN name with the pointer indicating the DN table without having a format of a table.

The SRGW 400 generates a plurality of VRFs 210 corresponding to each of the plurality of gNBs 130. The SRGW 400 generates a plurality of VRFs 220 corresponding to each of the plurality of DNs 30. The SRGW 400 then advertises information of the plurality of VRFs 210 and the plurality of VRFs 220 to the N4BGPC 300.

The SRGW 400 may transmit a BGP message, including the information of the plurality of VRFs 210 and the plurality of VRFs 220, to the N4BGPC 300. The SRGW 400 may transmit a BGP update message, including the information of the plurality of VRFs 210 and the plurality of VRFs 220, to the N4BGPC 300. Such a message may be described as a GW Discovery Route.

The SRGW 400 may configure all of the combinations of the VRFs 210 and the VRFs 220 to advertise information of all of the combinations to the N4BGPC 300. In addition, the SRGW 400 may advertise the information of all of the VRFs 210 and the VRFs 220 to the N4BGPC 300 and the N4BGPC 300 may configure all of the combinations of the VRFs 210 and the VRFs 220. The former may be described as a first manner, and the latter may be described as a second manner.

For the first manner, for each of all combinations of the VRFs 210 and the VRFs 220, the SRGW 400 may generate a GW Discovery Route which has: the N3RAN prefix and the N6DN SID being stored in the NLRI and the N6DN community; and the N3RAN community being stored in the community attribute, and advertises the GW Discovery Route to the N4BGPC 300. The GW Discovery Route may be a BGP-LS (Link State) Route.

Here, an example of a case is described, in which the SRGW 400 includes a first VRF 210, a second VRF 210, a third VRF 210, a first VRF 220, a second VRF 220 and a third VRF 220.

For the combination of the first VRF 210 and the first VRF 220, the SRGW 400 generates a GW Discovery Route which has: an N3RAN prefix corresponding to the first VRF 210 and an N6DN SID corresponding to the first VRF 220 being stored in an NLRI in an MP_REACH_NLRI attribute; and the N3RAN community corresponding to the first VRF 210 and the N6DN community corresponding to the first VRF 220 being stored in the community attribute. The N6DN SID corresponding to the first VRF 220 may store a BGP-LS attribute. The N3RAN prefix corresponding to the first VRF 210 may be an address of one or more gNBs 130 connected to the first VRF 210. The N6DN SID corresponding to the first VRF 220 may be an SID indicating the first VRF 220 in the SRGW 400. The SID indicating the first VRF 220 may be a common Anycast SID indicating the first VRF 220 that exists in each of a plurality of SRGWs 400. Alternatively, the SID indicating the first VRF 220 may be an SID of a VRF 250 of one or more PE (Provider Edge) router 50 that are connected to the first VRF 220.

For the combination of the first VRF 210 and the second VRF 220, the SRGW 400 generates a GW Discovery Route which has: an N3RAN prefix corresponding to the first VRF 210 and an N6DN SID corresponding to the second VRF 220 being stored in an NLRI in an MP_REACH_NLRI attribute; and the N3RAN community corresponding to the first VRF 210 and the N6DN community corresponding to the second VRF 220 being stored in the community attribute. The N6DN SID corresponding to the second VRF 220 may store a BGP-LS attribute. In addition, for the combination of the first VRF 210 and the third VRF 220, the SRGW 400 generates a GW Discovery Route which has: an N3RAN prefix corresponding to the first VRF 210 and an N6DN SID corresponding to the third VRF 220 being stored in an NLRI in an MP_REACH_NLRI attribute; and the N3RAN community corresponding to the first VRF 210 and the N6DN community corresponding to the third VRF 220 being stored in the community attribute. The N6DN SID corresponding to the third VRF 220 may store a BGP-LS attribute.

For the combination of the second VRF 210 and the first VRF 220, the SRGW 400 generates a GW Discovery Route which has: an N3RAN prefix corresponding to the second VRF 210 and an N6DN SID corresponding to the first VRF 220 being stored in an NLRI in an MP_REACH_NLRI attribute; and the N3RAN community corresponding to the second VRF 210 and the N6DN community corresponding to the first VRF 220 being stored in the community attribute. The N6DN SID corresponding to the first VRF 220 may store a BGP-LS attribute. In addition, for the combination of the second VRF 210 and the second VRF 220, the SRGW 400 generates a GW Discovery Route which has: an N3RAN prefix corresponding to the second VRF 210 and an N6DN SID corresponding to the second VRF 220 being stored in an NLRI in an MP_REACH_NLRI attribute; and the N3RAN community corresponding to the second VRF 210 and the N6DN community corresponding to the second VRF 220 being stored in the community attribute. The N6DN SID corresponding to the second VRF 220 may store a BGP-LS attribute. In addition, for the combination of the second VRF 210 and the third VRF 220, the SRGW 400 generates a GW Discovery Route which has: an N3RAN prefix corresponding to the second VRF 210 and an N6DN SID corresponding to the third VRF 220 being stored in an NLRI in an MP_REACH_NLRI attribute; and the N3RAN community corresponding to the second VRF 210 and the N6DN community corresponding to the third VRF 220 being stored in the community attribute. The N6DN SID corresponding to the third VRF 220 may store a BGP-LS attribute.

For the combination of the third VRF 210 and the first VRF 220, the SRGW 400 generates a GW Discovery Route which has: an N3RAN prefix corresponding to the third VRF 210 and an N6DN SID corresponding to the first VRF 220 being stored in an NLRI in an MP_REACH_NLRI attribute; and the N3RAN community corresponding to the third VRF 210 and the N6DN community corresponding to the first VRF 220 being stored in the community attribute. The N6DN SID corresponding to the first VRF 220 may store a BGP-LS attribute. In addition, for the combination of the third VRF 210 and the second VRF 220, the SRGW 400 generates a GW Discovery Route which has: an N3RAN prefix corresponding to the third VRF 210 and an N6DN SID corresponding to the second VRF 220 being stored in an NLRI in an MP_REACH_NLRI attribute; and the N3RAN community corresponding to the third VRF 210 and the N6DN community corresponding to the second VRF 220 being stored in the community attribute. The N6DN SID corresponding to the second VRF 220 may store a BGP-LS attribute. In addition, for the combination of the third VRF 210 and the third VRF 220, the SRGW 400 generates a GW Discovery Route which has: an N3RAN prefix corresponding to the third VRF 210 and an N6DN SID corresponding to the third VRF 220 being stored in an NLRI in an MP_REACH_NLRI attribute; and the N3RAN community corresponding to the third VRF 210 and the N6DN community corresponding to the third VRF 220 being stored in the community attribute. The N6DN SID corresponding to the third VRF 220 may store a BGP-LS attribute.

For the second manner, the SRGW 400 may generate the GW Discovery Route by dividing the NLRI types. For example, a type of an NLRI that stores the N3RAN prefix is referred to as Access, and a type of an NLRI that stores the N6DN SID is referred to as Core. For a plurality of VRFs 210, the SRGW 400 may generate, with the NLRI type as Access, the GW Discovery Route which has: the N3RAN prefix being stored in the NLRI in the MP_REACH_NLRI attribute; and the N3RAN community being stored in the community attribute. If there are a plurality of VRFs 210 that are accessible to the same UPF 120, the N3RAN prefixes included in the plurality of VRFs 210 may be stored in one BGP update message having a common N3RAN community attribute. In addition, for a plurality of VRFs 220, the SRGW 400 may generate, with the NLRI type as Core, the GW Discovery Route which has: a node ID indicating the SRGW 400 itself being stored in the NLRI in the MP_REACH_NLRI attribute; the N6DN community being stored in the community attribute; and the N6DN SID added thereto. The SRGW 400 then advertises the generated GW Discovery Route to the N4BGPC 300. The GW Discovery Route may be a BGP-LS Route.

Here, an example of a case is described, in which the SRGW 400 includes a first VRF 210, a second VRF 210, a third VRF 210, a first VRF 220, a second VRF 220 and a third VRF 220.

The SRGW 400 may generate, with the NLRI type as Access, the GW Discovery Route which has: the N3RAN prefix corresponding to the first VRF 210 being stored in the NLRI in the MP_REACH_NLRI attribute; and the N3RAN community corresponding to the first VRF 210 being stored in the community attribute. In addition, the SRGW 400 may generate, with the NLRI type as Access, the GW Discovery Route which has: the N3RAN prefix corresponding to the second VRF 210 being stored in the NLRI in the MP_REACH_NLRI attribute; and the N3RAN community corresponding to the second VRF 210 being stored in the community attribute. In addition, the SRGW 400 may generate, with the NLRI type as Access, the GW Discovery Route which has: the N3RAN prefix corresponding to the third VRF 210 being stored in the NLRI in the MP_REACH_NLRI attribute; and the N3RAN community corresponding to the third VRF 210 being stored in the community attribute.

In addition, the SRGW 400 may generate, with the NLRI type as Core, the GW Discovery Route which has: a node ID indicating the SRGW 400 itself being stored in the NLRI in the MP_REACH_NLRI attribute; the N6DN community corresponding to the first VRF 220 being stored in the community attribute; and the N6DN SID corresponding to the first VRF 220 added thereto. In addition, the SRGW 400 may generate, with the NLRI type as Core, the GW Discovery Route which has: a node ID indicating the SRGW 400 itself being stored in the NLRI in the MP_REACH_NLRI attribute; the N6DN community corresponding to the second VRF 220 being stored in the community attribute; and the N6DN SID corresponding to the second VRF 220 added thereto. In addition, the SRGW 400 may generate, with the NLRI type as Core, the GW Discovery Route which has: a node ID indicating the SRGW 400 itself being stored in the NLRI in the MP_REACH_NLRI attribute; the N6DN community corresponding to the third VRF 220 being stored in the community attribute; and the N6DN SID corresponding to the third VRF 220 added thereto.

For the first manner, the N4BGPC 300 can grasp a combination of the VRF 210 and the VRF 220 by the received GW Discovery Route. For the second manner, the N4BGPC 300 may configure all combinations of the VRFs 210 and the VRFs 220.

When the N6DN community of the GW Discovery Route acquired from the SRGW 400 matches any of community attributes of the DN community association table, the N4BGPC 300 identifies a DN name corresponding to the matched community attribute. The N4BGPC 300 then identifies a DN table pointer corresponding to the identified DN name by referring to the DN table association table.

The N4BGPC 300 registers, to the DN table indicated by the identified DN table pointer, the N3RAN prefix, the N6DN SID and the N3RAN community included in the GW Discovery Route. The N4BGPC 300 registers, to the DN tables each corresponding to each of the plurality of DN names, information of a plurality of GW Discovery Routes, received from the SRGW 400. In this manner, the database is ready. The DN table may be a Patricia tree structure with the N3RAN prefix as a key.

The N4BGPC 300 acquires PFCP session information of the UE 40 from the SMF 110. The N4BGPC 300 acquires the PFCP session information notified from the SMF 110 when the UE 40 is attached.

The PFCP session information may include an address of the UE 40. The PFCP session information may include an address of a gNB 130 contained in the UE 40. The PFCP session information may include an address of a UPF 120 corresponding to the UE 40. The PFCP session information may include a network instance corresponding to the UE 40. The PFCP session information may include an access network instance. The PFCP session information may include a core network instance. The PFCP session information may include a Core DN name.

The N4BGPC 300 generates path information addressed to the UPF 120 when the PFCP session information of the UE 40 is acquired. The N4BGPC 300 identifies the DN table indicated by a pointer, by searching the Core DN name included in the PFCP session information from the DN table association table and identifying the pointer indicating the DN table corresponding to the Core DN name. The N4BGPC 300 searches the identified DN table with the address (N3RAN prefix) of the gNB 130 included in the PFCP session information as a key, and identifies an entry of the N3RAN prefix of the DN table. The searching performed on the DN table may identify the N3RAN prefix entry by the longest prefix match.

The N4BGPC 300 generates path information for a destination address of the UPF 120 by using the N6DN SID and the N3RAN community within the entry, and advertises to the SRGW 400. For example, the N4BGPC 300 generates, as a community attribute the path, a BGP update message which has: the address of the UPF 120 being stored in the NLRI; the address of the N4BGPC 300 being stored in a Nexthop-Address; the N6DN SID within the entry added to the NLRI, the N3RAN community within the entry stored thereon, and advertises to the SRGW 400. The path information for the destination address of the UPF 120 being advertised to the SRGW 400 may be path information indicating the GTP 4.D or GTP 6.D.

The N4BGPC 300 may use a community attribute identifying the N6DN VRF, for the path information for the destination address of the UPF 120 being advertised to a plurality of SRGWs 400, having the N6DN SIDs different from each other. When the VRF 220 can be identified as the N6DN VRF in all of targeted SRGWs 400 by the community, the N4BGPC 300 may advertise only one common UPF 120 destination address path information obtained by adding the N6DN community to all of the SRGWs 400 instead of advertising the plurality of UPF 120 destination address path information having the N6DN SID corresponding to the each individual SRGW 400 added thereto. A community attribute identifying the N6DN may be a Color community. A community attribute identifying the N6DN may be used by defining a community attribute that is directly intended to identify the N6DN.

The N4BGPC 300 knows the N3RAN community in advance, and when advertising the path information, which is addressed to the UPF 120 that identifies the N6DN VRF by the community attribute, to the SRGW 400, an UPF 120 path to which only the community attribute identifying the N6DN is added without searching the DN table may be advertised. At this time, the SRGW 400 may not advertise the GW Discovery Route to the N4BGPC 300.

The SRGW 400 recognizes that the path information is path information to be imported into the VRF 210 of the N3RAN by referring to the community attribute of the received path information, to import the path information whose destination is the UPF 120 to the VRF 210.

In this manner, the SRGW 400 can acquire a packet that is transmitted by the UE 40, which would be conventionally transferred to the UPF 120, and transfers the packet to the DN 30.

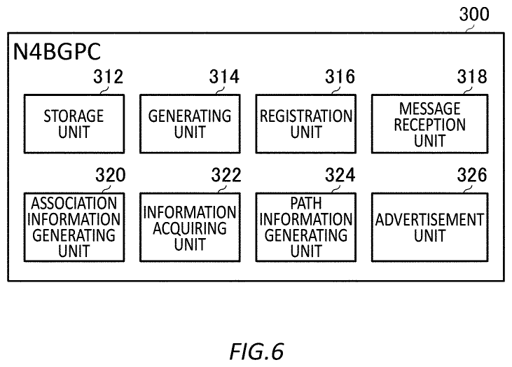

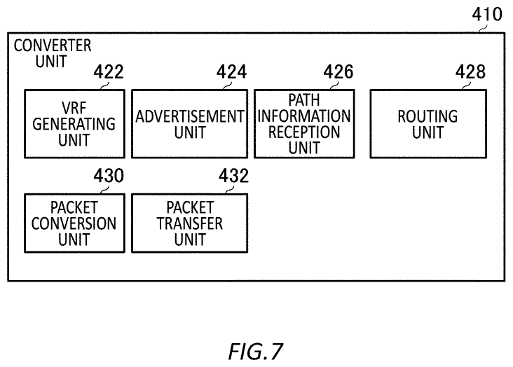

FIG. 6 schematically illustrates an example of a functional configuration of an N4BGPC 300. FIG. 7 schematically illustrates an example of a logical configuration of a converter unit 410. The N4BGPC 300 includes a storage unit 312, a generating unit 314, a registration unit 316, a message reception unit 318, an association information generating unit 320, an information acquiring unit 322, a path information generating unit 324 and an advertisement unit 326. The converter unit 410 includes a VRF generating unit 422, an advertisement unit 424, a path information reception unit 426, a routing unit 428, a packet conversion unit 430 and a packet transfer unit 432.

The generating unit 314 generates DN community association information. The generating unit 314 generates, for example, a DN community association table. The generating unit 314 stores the generated DN community association information in the storage unit 312.

The registration unit 316 registers a combination of a plurality of DN names, and the community attributes to the DN community association information. The registration unit 316 may perform the registering according to an instruction from an operator or the like or the communication system 10.

The generating unit 314 generates DN related information. The generating unit 314 generates, for example, a DN table. The generating unit 314 stores the generated DN related information in the storage unit 312.

The generating unit 314 generates DN related information association information. The generating unit 314 generates, for example, a DN table association table. The generating unit 314 stores the generated DN related information association information in the storage unit 312.

The VRF generating unit 422 generates a VRF. For example, the VRF generating unit 422 generates a plurality of gNBVRFs corresponding to each of the plurality of gNBs 130. The VRF 210 may be an example of the gNBVRF. For example, the VRF generating unit 422 generates a plurality of DNVRFs corresponding to each of the plurality of DNs 30. The VRF 220 may be an example of the DNVRF.

The advertisement unit 424 advertises information of the VRF that is generated by the VRF generating unit 422 to the N4BGPC 300. The advertisement unit 424 advertises, to the N4BGPC 300, a message including information of the plurality of gNBVRFs and the plurality of DNVRFs generated by the VRF generating unit 422, for example. The message may be a BGP message. The message may be a BGP update message. The message may be a GW Discovery Route. The GW Discovery Route may be a BGP-LS Route. The advertisement unit 424 may be an example of a message advertisement unit. The message reception unit 318 receives a message that is advertised by the advertisement unit 424.

The advertisement unit 424 may configure all of the combinations of the gNBVRFs and the DNVRFs to advertise information of all of the combinations to the N4BGPC 300. For example, the advertisement unit 424 advertises, to the N4BGPC 300, for each of all combinations of the plurality of gNBVRFs and the plurality of DNVRFs, a message which has: an N3RAN prefix corresponding to the gNBVRF and an N6DN SID corresponding to the DNVRF being stored in the NRLI; and an N3RAN community corresponding to the gNBVRF and an N6DN community corresponding to the DNVRF being stored in the community attribute.

As a particular example, the advertisement unit 424 advertises, to the N4BGPC 300, for a combination of a first gNBVRF among the plurality of gNBVRFs and a first DNVRF among the plurality of DNVRFs, a message which has: an N3RAN prefix corresponding to the first gNBVRF and an N6DN SID corresponding to the first DNVRF being stored in the NLRI in the MP_REACH_NLRI attribute; and an N3RAN community corresponding to the first gNBVRF and an N6DN community corresponding to the first DNVRF being stored in the community attribute. The N6DN SID corresponding to the first DNVRF may store a BGP-LS attribute. The N3RAN prefix corresponding to the first gNBVRF may be an address of one or more gNBs 130 connected to the first gNBVRF. The N6DN SID corresponding to the first DNVRF may be an SID indicating the first DNVRF in the SRGW 400. The SID indicating the first DNVRF may be a common Anycast SID indicating the first DNVRF that exists in each of a plurality of SRGWs 400. In addition, the SID indicating the first DNVRF may be an SID of the VRF 250 of one or more PE routers 50 connected to the first DNVRF.

In addition, the advertisement unit 424 may advertise the information of all of the gNBVRFs and the DNVRFs to the N4BGPC 300 and the N4BGPC 300 may configure all of the combinations of the gNBVRFs and the DNVRFs. For example, the advertisement unit 424 advertises, to the N4BGPC 300, for the plurality of gNBVRFs, with an NLRI type as Access, a message which has: the N3RAN prefix corresponding to the gBNVRF being stored in the NLRI in the MP_REACH_NLRI attribute; and the N3RAN community corresponding to the gBNVRF being stored in the community attribute, and advertise to the N4BGPC 300, for the plurality of GNVRFs, with the NLRI type as Core, a message which has: a node ID indicating the SRGW 400 being stored in the NLRI in the MP_REACH_NLRI attribute; the N6DN community corresponding to the GNVRF being stored in the community attribute; and the N6DN SID corresponding to the GNVRF added thereto.

As a particular example, the advertisement unit 424 advertises, to the N4BGPC 300, for a first gNBVRF among the plurality of gNBVRFs, with the NLRI type as Access, a message which has: the N3RAN prefix corresponding to the first gNBVRF being stored in the NLRI in the MP_REACH_NLRI attribute; and the N3RAN community corresponding to the first gNBVRF being stored in the community attribute, and advertise to the N4BGPC 300, for a first DNVRF among the plurality of DNVRFs, with the NLRI type as Core, a message which has: a node ID indicating the SRGW 400 being stored in the NLRI in the MP_REACH_NLRI attribute; the N6DN community corresponding to the first DNVRF being stored in the community attribute; and the N6DN SID corresponding to the first DNVRF added thereto.

The association information generating unit 320 generates association information associating the plurality of gNBVRFs with the plurality of DNVRFs based on the message received by the message reception unit 318. When the N6DN community included in the message matches a community attribute of any of the DN community association information stored in the storage unit 312, the association information generating unit 320 identifies a DN name corresponding to the matched community attribute. Then, the association information generating unit 320 identifies DN related information indicated by a DN related information pointer corresponding to the identified DN name by referring to the DN related information association information stored in the storage unit 312. The association information generating unit 320 registers, to the identified DN related information, the N3RAN prefix, the N6DN SID and the N3RAN community included in the message. The association information generating unit 320 registers the plurality of message information received from the advertisement unit 424 to DN related information corresponding to each of the plurality of DN names. In this manner, the association information generating unit 320 generates association information. That is, the association information may be DN related information to which a plurality of information is registered.

The information acquiring unit 322 acquires PFCP session information of the UE 40. The information acquiring unit 322 may acquire the PFCP session information of the UE 40 from the SMF 110. For example, the information acquiring unit 322 acquires the PFCP session information notified from the SMF 110 when the UE 40 is attached to the mobile network.

The path information generating unit 324 generates path information addressed to the UPF 120 when the PFCP session information of the UE 40 is acquired by the information acquiring unit 322. The path information generating unit 324 may generate path information with respect to the destination address of the UPF 120 corresponding to the UE 40, the path information including the SID of the DNVRF corresponding to the UE 40, based on the PFCP session information and the association information generated by the association information generating unit 320.

For example, the path information generating unit 324 identifies a pointer for indicating association information corresponding to the DN name by searching the DN related information association information stored in the storage unit 312 with the DN name included in the PFCP session information, to identify the association information indicated by the pointer. The path information generating unit 324 identifies an N3RAN prefix corresponding to the address of a gNB in the association information by searching the identified association information with the address of the gNB included in the PFCP session information as a key, and generates path information by using the N6DN SID and the N3RAN community corresponding to the identified N3RAN prefix.

As a particular example, when the association information is the DN table, the path information generating unit 324 identifies the DN table corresponding to the DN name, searches the DN table with the address (N3RAN prefix) of the gNB included in the PFCP session information as a key, and identifies an entry of the N3RAN prefix of the DN table. Then, the path information generating unit 324 generates path information by using the N6DN SID, N3RAN community within the identified entry.

The advertisement unit 326 advertises the path information generated by the path information generating unit 324 to the SRGW 400. For example, the advertisement unit 326 generates, as a community attribute the path, a BGP update message which has: the address of the UPF 120 being stored in the NLRI; the address of the N4BGPC 300 being stored in a Nexthop-Address; the N6DN SID within the entry added to the NLRI, the N3RAN community within the entry stored thereon, and advertise it to the SRGW 400. The advertisement unit 326 may be an example of a path information advertisement unit.

The path information generating unit 324 may use a community attribute identifying the N6DN VRF, for the path information for the destination address of the UPF 120 being advertised to a plurality of SRGWs 400, having the N6DN SIDs different from each other. When the DNVRF can be identified as the N6DN VRF in all of targeted SRGWs 400 by the community, the advertisement unit 326 may advertise only one common UPF 120 destination address path information obtained by adding the N6DN community to all of the SRGWs 400 instead of advertising the plurality of UPF 120 destination address path information having the N6DN SID corresponding to the each individual SRGW 400 added thereto.

Note that the advertisement unit 326 knows the N3RAN community in advance, and when advertising the path information, which is addressed to the UPF 120 that identifies the N6DN VRF by the community attribute, to the SRGW 400, an UPF 120 path without searching the DN table may be advertised. At this time, the SRGW 400 may not advertise the GW Discovery Route to the N4BGPC 300.

The path information reception unit 426 receives the path information advertised by the advertisement unit 326. The routing unit 428 performs a routing based on the path information received by the advertisement unit 326. The routing unit 428 may recognize that the path information is path information to be imported into the VRF 210 of the N3RAN by referring to the community attribute of the received path information. In this case, the routing unit 428 imports the path information whose destination is the UPF 120 to the VRF 210.

The packet conversion unit 430 converts a packet compliant with the GTP-U into a packet compliant with the SRv6. The packet conversion unit 430 may convert a packet compliant with the GTP-U that is received from the mobile network into a packet compliant with the SRv6.

The packet transfer unit 432 transfers the packet. The packet transfer unit 432 transfers the packet according to the routing by the routing unit 428. For example, the packet transfer unit 432 performs conversion, by the packet conversion unit 430, on the packet whose destination is the UPF 120, which is transmitted by the UE 40 and arrived to the VRF 210, and performs control for transferring the converted packet to a corresponding DN 30 via a corresponding VRF 220.

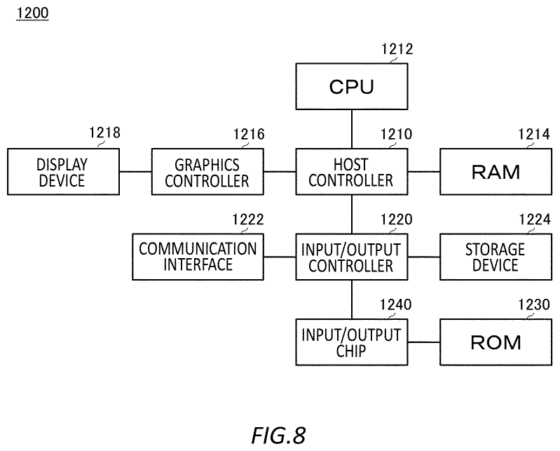

FIG. 8 schematically illustrates an example of a hardware configuration of a computer 1200 that functions as an N4BGPC 300 or a SRGW 400. A program installed in the computer 1200 can cause the computer 1200 to function as one or more “units” of an apparatus according to the present embodiment, or cause the computer 1200 to perform operations associated with the apparatus or perform one or more “units” thereof according to the present embodiment, and/or cause the computer 1200 to perform the process according to the present embodiment or perform the steps of the process. Such a program may be executed by a CPU 1212 to cause the computer 1200 to perform particular operations associated with some or all of the blocks in the flowcharts and block diagrams described in the specification.

The computer 1200 according to the present embodiment includes the CPU 1212, a RAM 1214, and a graphics controller 1216, which are connected to each other via a host controller 1210. The computer 1200 also includes input/output units such as a communication interface 1222, a storage device 1224, a DVD drive and an IC card drive, which are connected to the host controller 1210 via an input/output controller 1220. The DVD drive may be a DVD-ROM drive, a DVD-RAM drive, etc. The storage device 1224 may be a hard disk drive, a solid-state drive, and the like. The computer 1200 also includes a ROM 1230 and a legacy input/output unit such as a keyboard, which are connected to the input/output controller 1220 via an input/output chip 1240.

The CPU 1212 operates according to the programs stored in the ROM 1230 and the RAM 1214, thereby controlling each unit. The graphics controller 1216 obtains image data which is generated by the CPU 1212 in a frame buffer or the like provided in the RAM 1214 or in itself so as to cause the image data to be displayed on a display device 1218.

The communication interface 1222 communicates with other electronic devices via a network. The storage device 1224 stores a program and data used by the CPU 1212 in the computer 1200. The DVD drive reads the programs or the data from the DVD-ROM or the like, and provides the storage device 1224 with the programs or the data. The IC card drive reads the program and data from an IC card, and/or writes the program and data to the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer-readable storage medium such as the DVD-ROM or the IC card. The program is read from the computer-readable storage medium, installed into the storage device 1224, RAM 1214, or ROM 1230, which are also examples of a computer-readable storage medium, and executed by the CPU 1212. Information processing written in these programs is read by the computer 1200, and provides cooperation between the programs and the various types of hardware resources described above. A device or method may be constituted by realizing the operation or processing of information in accordance with the usage of the computer 1200.

For example, in a case where a communication is performed between the computer 1200 and an external device, the CPU 1212 may execute a communication program loaded in the RAM 1214 and instruct the communication interface 1222 to perform communication processing based on a process written in the communication program. The communication interface 1222, under control of the CPU 1212, reads transmission data stored on a transmission buffer region provided in a recording medium such as the RAM 1214, the storage device 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage device 1224, the DVD drive (DVD-ROM), the IC card, etc., and perform various types of processing on the data on the RAM 1214. Then, the CPU 1212 may write the processed data back in the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, to write the results back to the RAM 1214. In addition, the CPU 1212 may retrieve information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the plurality of entries, and read the attribute value of the second attribute stored in the entry, thereby obtaining the attribute value of the second attribute associated with the first attribute satisfying a predetermined condition.

The above-described program or software modules may be stored in the computer-readable storage medium on or near the computer 1200. In addition, a recording medium such as a hard disk or a RAM provided in a server system connected to a dedicated communication network or the Internet can be used as the computer-readable storage medium, thereby providing the program to the computer 1200 via the network.

Blocks in flowcharts and block diagrams in the present embodiments may represent steps of processes in which operations are performed or “units” of devices responsible for performing operations. A specific step and “unit” may be implemented by dedicated circuitry, programmable circuitry supplied along with a computer-readable instruction stored on a computer-readable storage medium, and/or a processor supplied along with the computer-readable instruction stored on the computer-readable storage medium. The dedicated circuitry may include a digital and/or analog hardware circuit, or may include an integrated circuit (IC) and/or a discrete circuit. The programmable circuitry may include, for example, a reconfigurable hardware circuit including logical AND, logical OR, logical XOR, logical NAND, logical NOR, and other logical operations, and a flip-flop, a register, and a memory element, such as a field-programmable gate array (FPGA) and a programmable logic array (PLA).

The computer-readable storage medium may include any tangible device capable of storing an instruction performed by an appropriate device, so that the computer-readable storage medium having the instruction stored thereon constitutes a product including an instruction that may be performed in order to provide means for performing an operation specified by a flowchart or a block diagram. Examples of the computer-readable storage medium may include an electronic storage medium, a magnetic storage medium, an optical storage medium, an electromagnetic storage medium, a semiconductor storage medium, and the like. A more specific example of the computer-readable storage medium may include floppy disk, diskette, hard disk, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disk (DVD), Blu-ray (registered trademark) disk, memory stick, integrated circuit card or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

The computer-readable instruction may be provided to a general purpose computer, a special purpose computer, or a processor or programmable circuitry of another programmable data processing apparatus locally or via a local area network (LAN), a wide area network (WAN) such as the Internet or the like in order that the general purpose computer, the special purpose computer, or the processor or the programmable circuitry of the other programmable data processing apparatus performs the computer-readable instruction to provide means for performing operations specified by the flowchart or the block diagram. Examples of the processor include a computer processor, a processing unit, a microprocessor, a digital signal processor, a controller, a microcontroller, and the like.

While the present invention has been described by way of the embodiments, the technical scope of the present invention is not limited to the above-described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 communication system
20 SRNW
30 DN
40 UE
50 PE router
110 SMF
120 UPF
130 gNB
202, 204, 206, 208, 210, 220 VRF
222 SID
250 VRF
300 N4BGPC
302 acquiring unit
304 matching unit
306 identification unit
308 advertisement unit
312 storage unit
314 generating unit
316 registration unit
318 message reception unit
320 association information generating unit
322 information acquiring unit
324 path information generating unit
326 advertisement unit
400 SRGW
410 converter unit
412 packet conversion unit
414 acquiring unit
416 SR policy generating unit
418 advertisement unit
420 packet transfer unit
422 VRF generating unit
424 advertisement unit
426 path information reception unit
428 routing unit
430 packet conversion unit
432 packet transfer unit
450 converter unit
510 PFCP session
1200 computer
1210 host controller
1212 CPU
1214 RAM
1216 graphics controller
1218 display device
1220 input/output controller
1222 communication interface
1224 storage device
1230 ROM
1240 input/output chip

What is claimed is:

1. A communication system comprising:
a controller; and
an SR gateway which converts a packet compliant with a GTP-U received from a mobile network into a packet compliant with an SRv6, wherein the SR gateway includes:
a VRF generating unit which generates: a plurality of gNBVRFs, each of which is a VRF corresponding to each of a plurality of gNBs; and a plurality of DNVRFs, each of which is a VRF corresponding to each of a plurality of DNs; and
a message advertisement unit which advertises a message to the controller, the message including information of the plurality of gNBVRFs and the plurality of DNVRFs generated by the VRF generating unit; and
the controller includes:
an association information generating unit which generates association information associating the plurality of gNBVRFs with the plurality of DNVRFs based on the message;
an information acquiring unit which acquires PFCP session information notified when a UE is attached;
a path information generating unit which generates, based on the PFCP session information and the association information, path information with respect to a destination address of a UPF corresponding to the UE, the path information including an SID of a DNVRF corresponding to the UE; and
a path information advertisement unit which advertises the path information to the SR gateway.

2. The communication system according to claim 1, wherein the message advertisement unit advertises, to the controller, for each of all combinations of the plurality of gNBVRFs and the plurality of DNVRFs, the message which has: an N3RAN prefix corresponding to the gNBVRF and an N6DN SID corresponding to the DNVRF stored in an NLRI; and an N3RAN community corresponding to the gNBVRF and an N6DN community corresponding to the DNVRF stored in a community attribute.

3. The communication system according to claim 2, wherein the message advertisement unit advertises, to the controller, for a combination of a first gNBVRF among the plurality of gNBVRFs and a first DNVRF among the plurality of DNVRFs, the message which has: an N3RAN prefix corresponding to the first gNBVRF and an N6DN SID corresponding to the first DNVRF being stored in an NLRI in an MP_REACH_NLRI attribute; and an N3RAN community corresponding to the first gNBVRF and an N6DN community corresponding to the first DNVRF being stored in a community attribute.

4. The communication system according to claim 3, wherein the N6DN SID corresponding to the first DNVRF is a common Anycast SID indicating a first DNVRF that exists in each of a plurality of SR gateways, each being identical to the SR gateway.

5. The communication system according to claim 1, wherein the message advertisement unit advertises, to the controller, for the plurality of gNBVRFs, with an NLRI type as Access, a message which has: an N3RAN prefix corresponding to the gBNVRF being stored in an NLRI in an MP_REACH_NLRI attribute; and an N3RAN community corresponding to the gBNVRF being stored in a community attribute, and advertise, to the controller, for the plurality of DNVRFs, with an NLRI type as Core, a message which has: a node ID indicating the SR gateway being stored in the NLRI in the MP_REACH_NLRI attribute; an N6DN community corresponding to the DNVRF being stored in the community attribute; and an N6DN SID corresponding to the DNVRF added thereto.

6. The communication system according to claim 5, wherein the message advertisement unit advertises, to the controller, for a first gNBVRF among the plurality of gNBVRFs, with the NLRI type as Access, a message which has: the N3RAN prefix corresponding to the first gNBVRF being stored in the NLRI of the MP_REACH_NLRI attribute; and the N3RAN community corresponding to the first gNBVRF being stored in the community attribute, and advertise, to the controller, for a first DNVRF among the plurality of DNVRFs, with the NLRI type as Core, a message which has: the node ID indicating the SR gateway being stored in the NLRI in the MP_REACH_NLRI attribute; the N6DN community corresponding to the first DNVRF being stored in the community attribute; and the N6DN SID corresponding to the first DNVRF added thereto.

7. The communication system according to claim 2, wherein
the controller includes:
a storage unit which stores DN community association information for associating DN name capable of identifying an N6DN indicating a VRF corresponding to a DN with a community attribute of the N6DN, and DN related information that is capable of registering an N3RAN prefix, an N6DN SID and an N3RAN community corresponding to each of a plurality of DN names, each being identical to the DN name, and
when the N6DN community included in the message advertised by the message advertisement unit matches a community attribute of any of the DN community association information, the association information generating unit identifies a DN name corresponding to the matched community attribute, and generates the association information by registering, to the DN related information corresponding to the identified DN name, the N3RAN prefix, the N6DN SID and the N3RAN community included in the message.

8. The communication system according to claim 3, wherein
the controller includes:
a storage unit which stores DN community association information for associating DN name capable of identifying an N6DN indicating a VRF corresponding to a DN with a community attribute of the N6DN, and DN related information that is capable of registering an N3RAN prefix, an N6DN SID and an N3RAN community corresponding to each of a plurality of DN names, each being identical to the DN name, and
when the N6DN community included in the message advertised by the message advertisement unit matches a community attribute of any of the DN community association information, the association information generating unit identifies a DN name corresponding to the matched community attribute, and generates the association information by registering, to the DN related information corresponding to the identified DN name, the N3RAN prefix, the N6DN SID and the N3RAN community included in the message.

9. The communication system according to claim 4, wherein
the controller includes:
a storage unit which stores DN community association information for associating DN name capable of identifying an N6DN indicating a VRF corresponding to a DN with a community attribute of the N6DN, and DN related information that is capable of registering an N3RAN prefix, an N6DN SID and an N3RAN community corresponding to each of a plurality of DN names, each being identical to the DN name, and
when the N6DN community included in the message advertised by the message advertisement unit matches a community attribute of any of the DN community association information, the association information generating unit identifies a DN name corresponding to the matched community attribute, and generates the association information by registering, to the DN related information corresponding to the identified DN name, the N3RAN prefix, the N6DN SID and the N3RAN community included in the message.

10. The communication system according to claim 5, wherein
the controller includes:
a storage unit which stores DN community association information for associating DN name capable of identifying an N6DN indicating a VRF corresponding to a DN with a community attribute of the N6DN, and DN related information that is capable of registering an N3RAN prefix, an N6DN SID and an N3RAN community corresponding to each of a plurality of DN names, each being identical to the DN name, and
when the N6DN community included in the message advertised by the message advertisement unit matches a community attribute of any of the DN community association information, the association information generating unit identifies a DN name corresponding to the matched community attribute, and generates the association information by registering, to the DN related information corresponding to the identified DN name, the N3RAN prefix, the N6DN SID and the N3RAN community included in the message.

11. The communication system according to claim 6, wherein
the controller includes:
a storage unit which stores DN community association information for associating DN name capable of identifying an N6DN indicating a VRF corresponding to a DN with a community attribute of the N6DN, and DN related information that is capable of registering an N3RAN prefix, an N6DN SID and an N3RAN community corresponding to each of a plurality of DN names, each being identical to the DN name, and
when the N6DN community included in the message advertised by the message advertisement unit matches a community attribute of any of the DN community association information, the association information generating unit identifies a DN name corresponding to the matched community attribute, and generates the association information by registering, to the DN related information corresponding to the identified DN name, the N3RAN prefix, the N6DN SID and the N3RAN community included in the message.

12. The communication system according to claim 7, wherein
the PFCP session information includes an address of the UE, an address of a gNB containing the UE, an address of a UPF corresponding to the UE, and a DN name of a DN with which the UE is in communication, and
the path information generating unit identifies the association information corresponding to a DN name included in the PFCP session information, identifies an N3RAN prefix corresponding to the address of the gNB in the association information by searching the identified association information with the address of the gNB included in the PFCP session information as a key, and generates the path information by using the N6DN SID and the N3RAN community corresponding to the identified N3RAN prefix.

13. The communication system according to claim 8, wherein
the PFCP session information includes an address of the UE, an address of a gNB containing the UE, an address of a UPF corresponding to the UE, and a DN name of a DN with which the UE is in communication, and
the path information generating unit identifies the association information corresponding to a DN name included in the PFCP session information, identifies an N3RAN prefix corresponding to the address of the gNB in the association information by searching the identified association information with the address of the gNB included in the PFCP session information as a key, and generates the path information by using the N6DN SID and the N3RAN community corresponding to the identified N3RAN prefix.

14. The communication system according to claim 9, wherein
the PFCP session information includes an address of the UE, an address of a gNB containing the UE, an address of a UPF corresponding to the UE, and a DN name of a DN with which the UE is in communication, and
the path information generating unit identifies the association information corresponding to a DN name included in the PFCP session information, identifies an N3RAN prefix corresponding to the address of the gNB in the association information by searching the identified association information with the address of the gNB included in the PFCP session information as a key, and generates the path information by using the N6DN SID and the N3RAN community corresponding to the identified N3RAN prefix.

15. A gateway comprising:
a converter unit which converts a packet compliant with a GTP-U received from a mobile network into a packet compliant with an SRv6;
a VRF generating unit which generates: a plurality of gNBVRFs, each of which is a VRF corresponding to each of a plurality of gNBs; and a plurality of DNVRFs, each of which is a VRF corresponding to each of a plurality of DNs; and
a message advertisement unit which advertises a message to a controller, the message including information of the plurality of gNBVRFs and the plurality of DNVRFs generated by the VRF generating unit.

16. A non-transitory computer-readable storage medium having a program stored thereon, the program causes a computer to function as a gateway comprising:
a converter unit which converts a packet compliant with a GTP-U received from a mobile network into a packet compliant with an SRv6;
a VRF generating unit which generates: a plurality of gNBVRFs, each of which is a VRF corresponding to each of a plurality of gNBs; and a plurality of DNVRFs, each of which is a VRF corresponding to each of a plurality of DNs; and
a message advertisement unit which advertises a message to a controller, the message including information of the plurality of gNBVRFs and the plurality of DNVRFs generated by the VRF generating unit.

17. A controller comprising:
a message reception unit which receives a message including information of a plurality of gNBVRFs, each of which is a VRF corresponding to each of a plurality of gNBs, and a plurality of DNVRFs, each of which is a VRF corresponding to each of a plurality of DNs;
an association information generating unit which generates association information for associating the plurality of gNBVRFs with the plurality of DNVRFs based on the message;
an information acquiring unit which acquires PFCP session information notified when a UE is attached;
a path information generating unit which generates, based on the PFCP session information and the association information, path information with respect to a destination address of a UPF corresponding to the UE, the path information including an SID of a DNVRF corresponding to the UE; and
a path information advertisement unit which advertises the path information to a gateway.

18. A non-transitory computer-readable storage medium having a program stored thereon, the program causes a computer to function as a controller comprising:
a message reception unit which receives a message including information of a plurality of gNBVRFs, each of which is a VRF corresponding to each of a plurality of gNBs, and a plurality of DNVRFs, each of which is a VRF corresponding to each of a plurality of DNs;
an association information generating unit which generates association information for associating the plurality of gNBVRFs with the plurality of DNVRFs based on the message;
an information acquiring unit which acquires PFCP session information notified when a UE is attached;
a path information generating unit which generates, based on the PFCP session information and the association information, path information with respect to a destination address of a UPF corresponding to the UE, the path information including an SID of a DNVRF corresponding to the UE; and
a path information advertisement unit which advertises the path information to a gateway.

19. A communication system comprising:
a controller;
an SR gateway which converts a packet compliant with a GTP-U received from a mobile network into a packet compliant with an SRv6, wherein the SR gateway includes:
an advertisement unit which advertises, when path information of an IP network and an SID of a VRF are received from the VRF connected to the IP network, an SR policy including information of the VRF to an ED of an NLRI and an SID of the SR gateway to the controller, and
the controller includes:
a matching unit which matches the VRF with the SR gateway based on information advertised from the VRF or preset information of the VRF and information that is advertised by the advertisement unit;
an identification unit which identifies, by referring to a PFCP session notified when a UE is attached, a UPF and a gNB corresponding to the IP network to which the VRF is connected; and
an advertisement unit which advertises path information of the UPF and an SID of the SR gateway to a VRF corresponding to the gNB identified by the identification unit.

20. A communication system according to claim 19, wherein the SR gateway includes:
a packet transfer unit which imports an SID of a VRF corresponding to the UPF as a path of the UPF, and transfers a predetermined type of packet to the UPF.
